(19) United States
(12) Patent Application Publication
(10) Pub. No.: US 2016/0150577 A1
(43) Pub. Date: May 26, 2016

(54) LTE BASED WIRELESS BACKHAUL CONNECTION TO CELLULAR NETWORK BASE STATION

(71) Applicant: TELEFONAKTIEBOLAGET L M ERICSSON (PUBL), Stockholm (SE)

(72) Inventors: Rui FAN, Beijing (CN); Zhiheng GUO, Beijing (CN); Jinhua LIU, Beijing (CN); Yu QIAN, Beijing (CN); Hai WANG, Beijing (CN)

(21) Appl. No.: 14/906,472

(22) PCT Filed: Jul. 25, 2013
(86) PCT No.: PCT/CN2013/080102

§ 371 Date: Jan. 20, 2016

(51) Int. Cl. H04W 76/02

(52) U.S. Cl. CPC H04W 76/02

(57) ABSTRACT

A network node controls a first base station of the cellular network to establish a wireless backhaul connection to a further network node. The wireless backhaul connection is implemented by an LTE radio access technology. Further, the network node routes backhaul data between the wireless backhaul connection and at least one core network of the cellular network. The further network node routes the backhaul data between the wireless backhaul connection and at least one second base station which serves a cell of the cellular network.

### TECHNICAL FIELD

The present invention relates to methods of transmitting backhaul data in a cellular network and to corresponding devices or systems.

### BACKGROUND

The current evolution of cellular networks is driven by increasing demand for capacity and data rates. This demand may be addressed by supplementing the cellular network with further cells. Rather than improving geographical coverage of the cellular network, such additional cells may be used to improve capacity and data rate in certain locations. Such additional cells are also referred to as pico cells.

For implementing an additional cell, e.g., a pico cell, typically also an additional base station (BS) is needed to serve the additional cell. Specifically in the case of pico cells, the location of the additional BS may result in difficult realization of a backhaul connection from the core network (CN) of the cellular network to the BS. For example, establishing a wired fibre optical backhaul link may be impractical due to existing building structures or establishing a wireless microwave backhaul connection may be impractical due to a lack of a line-of-sight connection to the new BS. These difficulties emerge for every additional cell which needs to be implemented. Moreover, the cellular network may implement different kinds of radio access technology (RAT), e.g., as specified for the GSM (Global System for Mobile Communication), UMTS (Universal Mobile Telecommunications System), or LTE (Long Term Evolution) technologies, and the requirements on the backhaul connection may differ between such different RATs, which may add further difficulties in realizing the backhaul connection to the new BS and when migrating between different RATs.

An alternative to using additional cells served by a BS with a wired or wireless backhaul connection to the CN is to supplement the cellular network with relay nodes. Such relay nodes obtain backhaul date from a regular BS of the cellular network, also referred to as donor BS, and serve UEs in a similar way as a BS. However, such relay nodes are limited to a specific RAT and need to be supported by the network infrastructure. Relay architectures for LTE are for example described in 3GPP (3^{rd} Generation Partnership Project) Technical Report (TR) 36.806 V9.0.0.

Accordingly, there is a need for techniques which allow for efficiently transmitting backhaul data between a CN and a BS of a cellular network.

### SUMMARY

According to an embodiment of the invention, a method for providing a backhaul connection in a cellular network is provided. According to the method, a network node controls a first BS of the cellular network to establish a wireless backhaul connection to a further network node. The wireless backhaul connection is implemented by an LTE RAT. Further, the network node routes backhaul data between the wireless backhaul connection and at least one CN of the cellular network. Further, the network node controls the further network node to route the backhaul data between the wireless backhaul connection and at least one second BS which serves a cell of the cellular network.

According to a further embodiment of the invention, a method for providing a backhaul connection in a cellular network is provided. According to the method, a network node establishes a wireless backhaul connection to a first BS of the cellular network. The wireless backhaul connection is implemented by an LTE RAT. Further, the network node routes backhaul data between the wireless backhaul connection and a at least one second BS which serves a cell of the cellular network.

According to a further embodiment of the invention, a network node for a cellular network is provided. The network node comprises a first interface with respect to at least one CN of the cellular network, a second interface with respect to a first BS, and at least one processor. The at least one processor is configured to control the first BS to establish a wireless backhaul connection to a further network node. The wireless backhaul radio connection is implemented by an LTE radio access technology. Further, the at least one processor is configured to route backhaul data between the wireless backhaul connection and the at least one CN. Further, the at least one processor is configured to control the further network node to route the backhaul data between the wireless backhaul connection and at least one second BS which serves a cell of the cellular network.

According to a further embodiment of the invention, a network node for a cellular network is provided. The network node comprises a radio interface for with respect to a first BS of the cellular network, a further interface with respect to at least one second BS, and at least one processor. The at least one processor is configured to establish a wireless backhaul connection of the network node to the first BS. The wireless backhaul connection is implemented by an LTE radio access technology. Further, the at least one processor is configured to route backhaul data between the wireless backhaul connection and a at least one second BS which serves a cell of the cellular network.

According to a further embodiment of the invention, a computer program is provided. The computer program comprises program code to be executed by at least one processor of a network node of a cellular network. Execution of the program code causes the network node to control a first BS to establish a wireless backhaul connection to a further network node. The wireless backhaul radio connection is implemented by an LTE radio access technology. Further, execution of the program code causes the network node to route backhaul data between the wireless backhaul connection and the at least one CN. Further, execution of the program code causes the network node to control the further network node to route the backhaul data between the wireless backhaul connection and at least one second BS which serves a cell of the cellular network.

According to a further embodiment of the invention, a computer program is provided. The computer program comprises program code to be executed by at least one processor of a network node of a cellular network. Execution of the program code causes the network node to establish a wireless backhaul connection of the network node to a first BS of the cellular network. The wireless backhaul connection is implemented by an LTE radio access technology. Further, execution of the program code causes the network node to route backhaul data between the wireless backhaul connection and a at least one second BS which serves a cell of the cellular network.

### BRIEF DESCRIPTION OF THE DRAWINGS

FIG. 1 schematically illustrates exemplary structures of a cellular network in which a wireless backhaul connection is implemented according to an embodiment of the invention.

FIG. 2 schematically illustrates functionalities of a network node for implementing the wireless backhaul connection.

FIG. 3 schematically illustrates a further network node for implementing the wireless backhaul connection.

FIG. 4 shows an exemplary protocol stack which may be used for implementing the wireless backhaul connection.

FIG. 5 shows exemplary control plane and user plane protocol stacks which may be used in a network node according to an embodiment of the invention.

FIG. 6 shows exemplary control plane and user plane protocol stacks which may be used in a network node according to an embodiment of the invention.

FIG. 7 shows exemplary procedures in accordance with an embodiment of the invention, which may be applied if the cellular network does not include a Mobility Management Entity (MME) and Home Subscriber Server (MME).

FIG. 8 shows exemplary procedures in accordance with an embodiment of the invention, which may be applied if the cellular network includes a HSS, but no MME.

FIG. 9 shows exemplary procedures in accordance with an embodiment of the invention, which may be applied if the cellular network includes a HSS and MME.

FIG. 10 shows a flowchart for illustrating a method according to an embodiment of the invention.

FIG. 11 shows a flowchart for illustrating a further method according to an embodiment of the invention.

FIG. 12 schematically illustrates a network node according to an embodiment of the invention.

FIG. 13 schematically illustrates a network node according to a further embodiment of the invention.

### DETAILED DESCRIPTION OF EMBODIMENTS

In the following, the invention will be explained in more detail by referring to exemplary embodiments and to the accompanying drawings. The illustrated embodiments relate to providing a backhaul connection to one or more BSs of a cellular network. The backhaul connection is used to transmit backhaul data between the BS and a CN of the cellular network. The backhaul data typically include both user plane data and control plane data. The cellular network may implement one or more RATs, e.g., GSM RAT, UMTS RAT, or LTE RAT.

According to the illustrated concepts, the backhaul connection to the BS is provided over a wireless backhaul connection between an LTE BS, referred to as backhaul eNB (BH eNB), and a network node which is connected to the BS. The wireless backhaul connection is established using an LTE RAT, e.g., LTE TDD (Time Division Duplex) or LTE FDD (Frequency Division Duplex). With respect to the BH eNB, the network node acts similar to an LTE user equipment (UE). In the following, the network node is therefore also referred to as backhaul UE (BH UE). A further network node is used to control establishment of the wireless backhaul connection and to route the backhaul data between the wireless backhaul connection and the CN. This further network node may specifically perform control functionalities for establishment of the LTE based wireless backhaul connection, as typically performed by an LTE CN, also referred to as EPC (Evolved Packet Core). Accordingly, this further network node is in the following also referred to as EPC agent. The EPC agent does not need to implement the complete set of control plane functionalities of the EPC, but only a subset thereof. The functionalities of the EPC agent may for example include control plane session establishment and radio bearer control. In some implementations, the EPC agent may also perform identification and authentication of the BH UE. Since the BH UE is assumed to be statically installed in a given location, mobility management functionalities are typically not required in the EPC agent. Further, the EPC agent also performs routing of the backhaul data between the CN and the wireless backhaul connection.

Using the EPC agent, the BH eNB, and the BH UE, the LTE based wireless backhaul connection may therefore be implemented without implementation of a complete EPC in the cellular network. Accordingly, the EPC agent, the BH eNB, and the BH UE may be used as a standalone system for implementing the wireless backhaul connection, without requiring any further LTE infrastructure. This is specifically beneficial if the cellular network does not (or not yet) implement LTE RAT, and the BS to which the backhaul connection is provided implements some other RAT, e.g., UMTS or GSM RAT. However, the wireless backhaul connection may also be used for connecting to an LTE BS, referred to as eNB. In such cases, typically also LTE infrastructure such as an MME, e.g., as specified in 3GPP TS 23.401 V12.1.0, or HSS, e.g., as specified in 3GPP TS 23.002 V12.2.0 and 23.008 V.12.0.1, will be present in the cellular network, and the EPC agent may utilize the functionalities of these nodes. In such cases, the BH eNB may be also be used for establishing a cell to serve regular UEs. The latter approach may be beneficial in view of efficient radio spectrum usage.

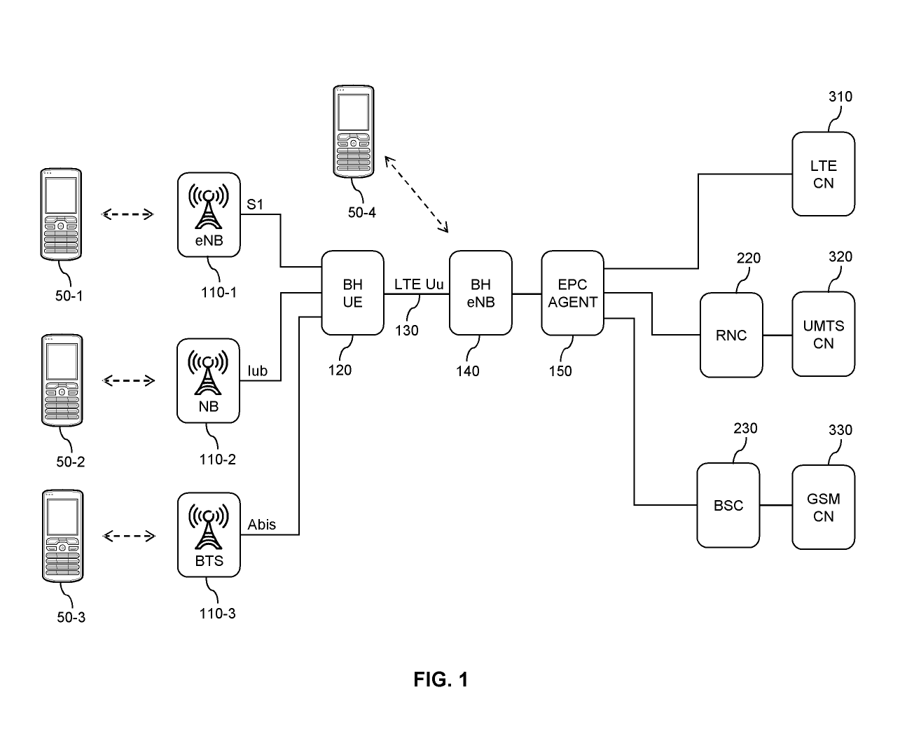

FIG. 1 schematically illustrates exemplary structures of the cellular network. Specifically, FIG. 1 shows various BSs of the cellular network which are each used to serve a respective cell of the cellular network, e.g., a pico cell. These BSs include an eNB 110-1 serving its cell using LTE RAT, a Node B (NB) 110-2, serving its cell using a UMTS RAT, and a Base Transceiver Station 110-3 serving its cell using GSM RAT. As further illustrated, a UE 50-1 may be served in the cell of the eNB 110-1, a UE 50-2 may be served in the cell of the NB 110-2, and a UE 50-3 may be served in the cell of the BTS 110-3.

For each of the different RATs used by the BSs 110-1, 110-2, 110-3, the cellular network provides corresponding CN infrastructure. Specifically, FIG. 1 illustrates an LTE CN 310 (which may also be referred to as EPC), an UMTS CN 320, and a GSM CN 330. Serving of the UEs 50-1, 50-2, 50-3 in the cells of the BSs 110-1, 110-2, 110-3 involves transmission of backhaul data between the BSs 110-1, 110-2, 110-3 and the respective CN 310, 320, 330. The backhaul data typically include user plane data and control plane data. The backhaul data may be transmitted from the CN 310, 320, 330 to the BS 110-1, 110-2, 110-3 and vice versa. The transmission endpoint of the user plane data is typically in the served UE 50-1, 50-2, 50-3.

Further, FIG. 1 illustrates the EPC agent 150, the BH eNB 140, and the BH UE 120 which are used to establish the wireless backhaul connection 130. As illustrated, the wireless backhaul connection is established over the LTE Uu radio interface. The EPC agent 150 routes the backhaul data between the respective CN 310, 320, 330 and the wireless backhaul connection 130 (over the BH eNB 140). The BH UE 120 in turn routes the backhaul data between the wireless backhaul connection 130 and the respective BS 110-1, 110-2, 110-3. In case of the UMTS RAT the connection between the UMTS CN 320 and the EPC agent goes via a control node 220 referred to as Radio Network Controller (RNC). Similarly, the connection between the GSM CN 330 and the EPC agent goes via a control node 230 referred to as Base Station Controller (BSC). The latter kind of nodes are centralized control nodes within the Radio Access Network (RAN), which at the same time are also responsible for routing user plane and/or control plane data.

As can further be seen from FIG. 1, interfaces as typically used for providing a backhaul connection of a BS, e.g., an interface of the eNB 110-1 referred to as S1, an interface of the NB 110-2 referred to as Iub, and an interface of the BTS 110-3 referred to as Abis, are routed over the LTE Uu radio interface. Here it should be noted that other backhaul interfaces could be handled in a similar manner, e.g., interfaces for establishing connectivity between different BSs, such as the X2 interface for connecting different eNBs.

As further illustrated, in some scenarios also the BH eNB 140 may also be utilized for serving a cell. In the example of FIG. 1, UE 50-4 is served in the cell of the BH eNB 140.

It is to be understood that while LTE RAT is used both for establishing the wireless backhaul connection 130 between the BH eNB 140 and the BH UE 120 and for serving the cell of the eNB 110-1, the RAT used for the wireless backhaul connection could still be different from the RAT used for serving the cell of the eNB 110-1. For example, the wireless backhaul connection 130 could be implemented by LTE TDD RAT, and the cell of the eNB 110-1 could be served by LTE FDD RAT.

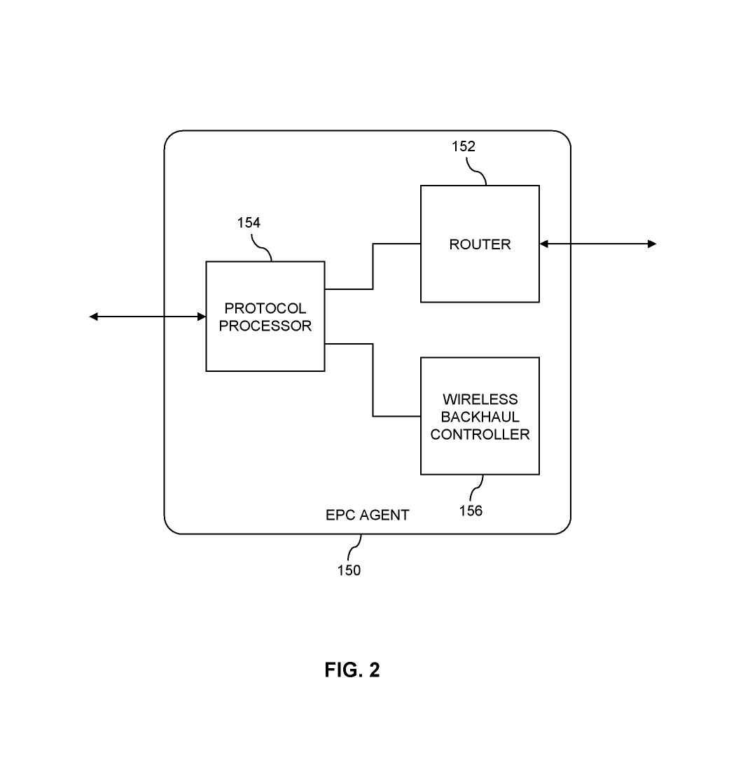

FIG. 2 shows a block diagram for illustrating functionalities of the EPC agent 150. As illustrated, the EPC agent 150 is provided with a router 152, a protocol processor 154, and a wireless backhaul controller 156.

The router 152 has the purpose of routing the backhaul data between the wireless backhaul connection 130 and the respective CN 310, 320, 330. The router 152 may be implemented on the basis of Internet Protocol (IP) routing mechanisms. The routing may be accomplished transparently, i.e., without requiring changes in the backhaul data as transmitted by the BS 110-1, 110-2, 110-3, CN 310, 320, 330, or control node 220, 230.

In some implementations, the different BSs 110-1, 110-2, 110-3 each have an individual IP address. However, to achieve conformity with existing LTE procedures, the BH UE 120 will be allocated one IP address by the LTE CN 310. The router 152 may in turn reside in multiple IP subnets. These IP subnets may be used for different purposes. In particular, they may be used for differentiating between the backhaul data of the different BSs 110-1, 110-2, 110-3. Other differentiations are possible as well, between Operations/Maintenance data and user plane data. For user plane data, the IP subnets could be used for differentiating between the different RATs used by the BSs 110-1, 110-2, 110-3. For implementing the differentiation, the IP addresses of the BSs 110-1, 110-2, 110-3 are allocated from the available IP addresses within the IP subnets in which the router 152 resides. The router 152 may monitor and record the source IP address of IP packets received from the BSs 110-1, 110-2, 110-3. When IP packets are transmitted to a certain BS 110-1, 110-2, 110-3, the router 152 may respond to an Address Resolution Protocol (ARP) request in place of this BS 110-1, 110-2, 110-3 so that these IP packets will first be transmitted to the router 152 of the EPC agent 150, which can then forward the IP packets to the BS 110-1, 110-2, 110-3.

The protocol processor 154 has the purpose of encapsulating the backhaul data transmitted to the wireless backhaul connection 130 as user plane data according to the protocol stack as used between EPC and eNB. The encapsulated user plane data will therefore be presented to the BH eNB as user plane data to be transmitted to the BH UE. For data coming from the wireless backhaul connection 130, the protocol processor 154 performs the inverse operation, i.e., decapsulates the backhaul data. Further details concerning the utilized protocol stack will be explained below. From network management perspective, the transparent routing means that there is no difference between the BSs 110-1, 110-2, 110-3 which use wireless backhaul connection 130 and BSs a regular backhaul connection.

The wireless backhaul controller 156 has the purpose of controlling establishment and management of the wireless backhaul connection 130. Corresponding control functionalities may include identifying and/or authenticating the BH UE 120 when establishing the wireless backhaul connection 130. Authentication may be IP based. In some cases, the control functionalities may also include distinguishing the BH UE 120 from regular UEs to be served by the cell of the BH eNB 140. The distinction may for example be performed using a UE identifier received during connection establishment, e.g., in a Non Access Stratum (NAS) message such as an AttachRequest or ServiceRequest. The EPC agent 150 may in turn store a list of UE identifiers which are assigned to BH UEs, and by comparison with this list, the BH UE 120 may be identified. Further, the control functionalities may include generation of control messages to the BH eNB 140 for setting up one or more radio bearers to the BH UE 120 for carrying the wireless backhaul connection 130. The latter may be accomplished in response to identifying and authenticating the BH UE 120. Further, the control functionalities may also include configuration of the BH UE 120 for routing the backhaul data to the desired BS 110-1, 110-2, 110-3.

As can be seen, the EPC agent 150 may thus perform control functionalities which are similar to those performed by an MME with respect to a regular eNB. However, not all functionalities of an MME, e.g., as specified in 3GPP TS 23.401, need to be implemented by the EPC agent 150. For example, mobility management functionalities are typically not required and may there for be omitted from the EPC agent 140. Accordingly, the EPC agent 150 may be easily implemented.

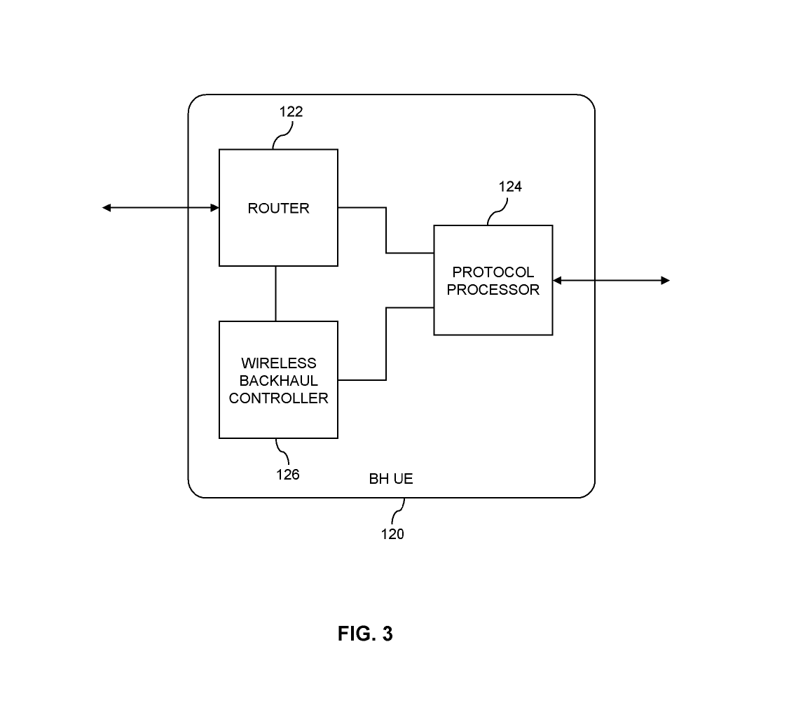

FIG. 3 shows a block diagram for illustrating functionalities of the BH UE 120. As illustrated, the BH UE 120 is provided with a router 122, a protocol processor 124, and a wireless backhaul controller 126.

The router 122 has the purpose of routing the backhaul data between the wireless backhaul connection 130 and the respective BS 110-1, 110-2, 110-3. The router 122 may be implemented on the basis of IP routing mechanisms. The routing may be accomplished transparently, i.e., without requiring changes in the backhaul data as transmitted by the BS 110-1, 110-2, 110-3, CN 310, 320, 330, or control node 220, 230.

The protocol processor 124 has the purpose of encapsulating the backhaul data transmitted to the wireless backhaul connection 130 as user plane data according to the protocol stack as used between EPC and eNB. The encapsulated user plane data will therefore be presented to the BH eNB as user plane data to be transmitted from the BH UE. For data coming from the wireless backhaul connection 130, the protocol processor 124 performs the inverse operation, i.e., decapsulates the backhaul data. Further details concerning the utilized protocol stack will be explained below.

The wireless backhaul controller 126 has the purpose of controlling establishment and management of the wireless backhaul connection 130. Corresponding control functionalities may be similar to radio link control functionalities of a regular LTE UE. Further, the control functionalities may include generation of control messages to the EPC agent 150 and/or BH eNB 140 or for establishing or managing Further, the control functionalities may also include configuration of the router 122 according to control information received from the EPC agent 150.

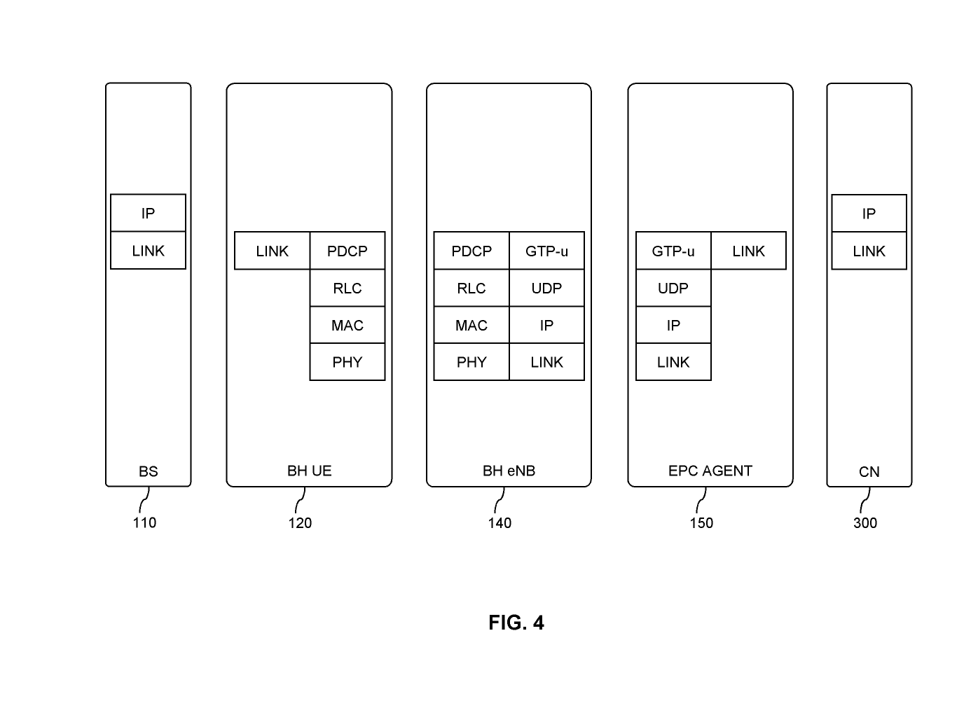

FIG. 4 further illustrates the protocol stack in the different nodes involved when using the wireless backhaul connection. Specifically, FIG. 4 illustrates the user plane protocol stacks in a BS 110, e.g., corresponding to the eNB 110-1, NB 110-2, or BTS 110-3, the BH UE 120, the BH eNB 140, the EPC agent 150, and a CN 300.

As can be seen from FIG. 4, an IP based link protocol, e.g., using Ethernet technology, may be used for transmitting the backhaul data between the BS 110 to the BH UE 120. The physical medium for implementing the link layer may for example be wire-based, but is not limited thereto.

In the BH UE 120, the backhaul data are translated according to the protocol stack used on the LTE Uu radio interface. As illustrated, this protocol stack includes a PDCP (Packet Data Convergence Protocol) layer, an RLC (Radio Link Control) layer, a MAC (Medium Access Control) layer, and a PHY (Physical) layer. Using this protocol stack, the backhaul data are encapsulated as user plane data.

The BH eNB 140 performs translation between the protocol stack of the LTE Uu radio interface and the protocol stack on the S1-U interface as typically used for transmission of user plane data between eNB and EPC. As illustrated in FIG. 4, this protocol stack includes a GTP-u (General Packet Radio Service Tunneling Protocol-User Plane) layer, a UDP (User Datagram Protocol) layer, an IP layer, and a link layer. The link layer may for example be based on Ethernet technology. The physical medium for implementing the link layer may for example be wire-based, but is not limited thereto.

The EPC agent 150 performs translation of the protocol stack of the S1-U interface and a protocol stack used for transmitting the backhaul data between the EPC agent and the CN 300. In the latter protocol stack, the link layer may for example be based on Ethernet technology. The physical medium for implementing the link layer may for example be wire-based, but is not limited thereto.

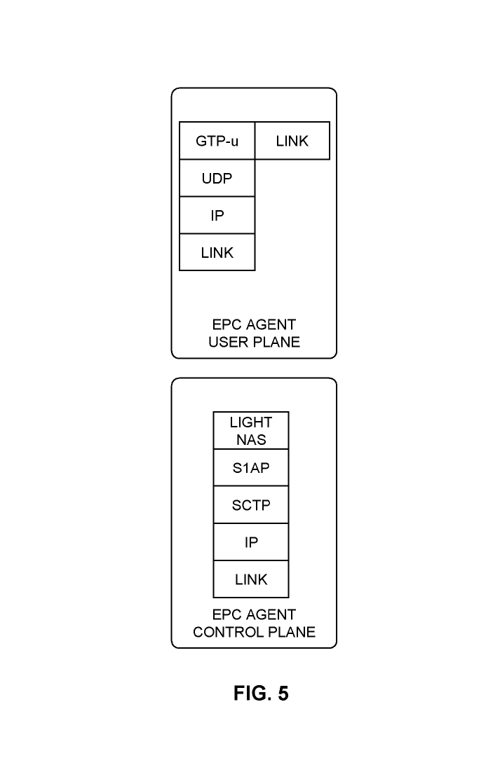

FIG. 5 illustrates exemplary user plane and control plane protocol stacks which may be implemented in the EPC agent 150 when no MME and other EPC infrastructure is available. In this case, the EPC agent may implement local control functionalities which are based on a protocol stack which includes a light NAS layer, an S1AP layer, an SCTP (Stream Control Transmission Protocol) layer, an IP layer, and a link layer. the link layer may for example be based on Ethernet technology. The physical medium for implementing the link layer may for example be wire-based, but is not limited thereto. The protocol stack is similar to that as implemented by an MME on the S1-MME interface, however with only a light NAS layer, which typically provides less functionalities than the NAS layer of the S1-MME interface. The user plane control stack for this case is as explained in connection with FIG. 4.

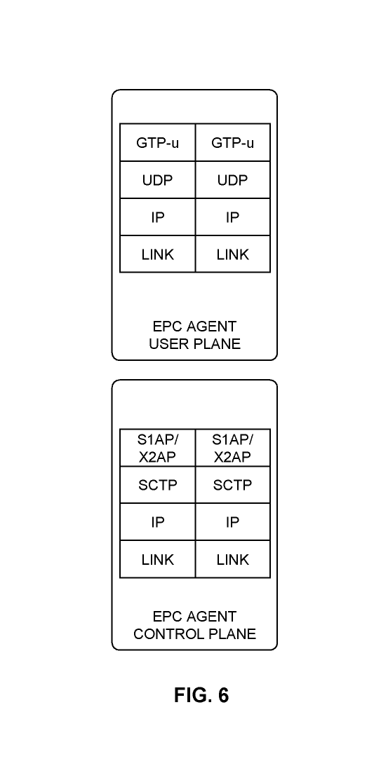

FIG. 6 illustrates exemplary user plane and control plane protocol stacks which may be implemented in the EPC agent 150 when an MME and other EPC infrastructure is available. In this case, the EPC agent may act as a proxy with respect to the MME, and a part of the control functionalities for establishing and managing the wireless backhaul connection may be implemented by the MME. However, the EPC agent 150 may still need to distinguish between BH UEs and regular UEs, due to the different handling of the backhaul data needed for the wireless backhaul connection. In this case, the control plane protocol stack provides an S1AP/X2AP layer, an SCTP layer, an IP layer, and a link layer, both with respect to the BH eNB 140 and with respect to the CN 300. In each case, the link layer may for example be based on Ethernet technology. The physical medium for implementing the link layer may for example be wire-based, but is not limited thereto. This protocol stack structure allows for forwarding of control plane traffic between the BH eNB 140 and the MME, which implements the NAS control functionalities. The EPC agent 150 may thus be used as an S1 proxy which forwards control plane data of the S1-MME interface between the BH eNB 140 and the MME. Further, the EPC agent 150 may thus be used as an S1 proxy which forwards control plane data of the X2 interface between the BH eNB 140 and another eNB.

In the case of FIG. 6, the user plane control stack for this case includes a GTP-u layer, an UDP layer, an IP layer, and a link layer, both with respect to the BH eNB 140 and with respect to the CN 300. The EPC agent 150 may therefore transparently forward user plane backhaul data. However, it should be noted that the backhaul data transmitted over the wireless backhaul connection still requires encapsulation/decapsulation to be handled as user plane data on the LTE Uu interface.

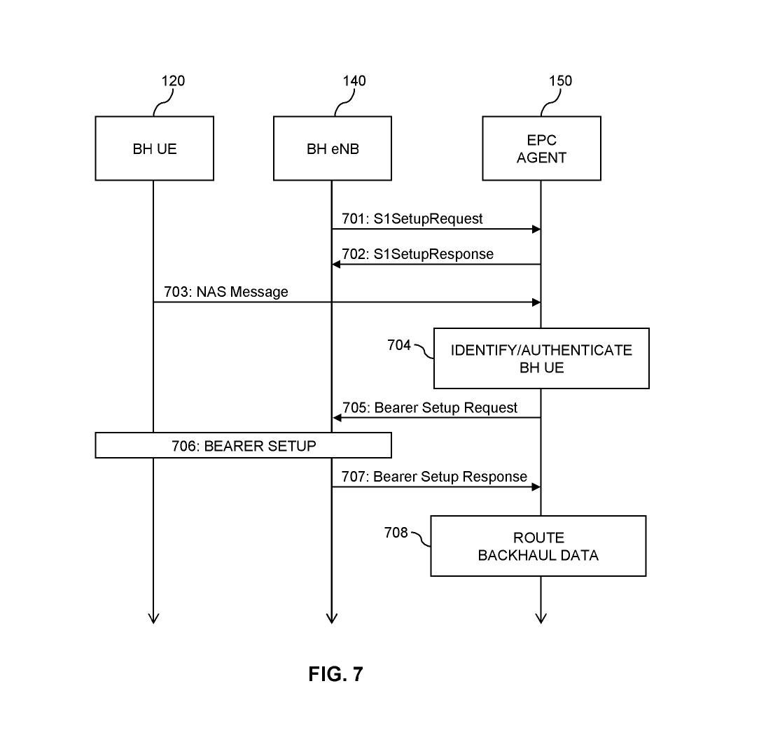

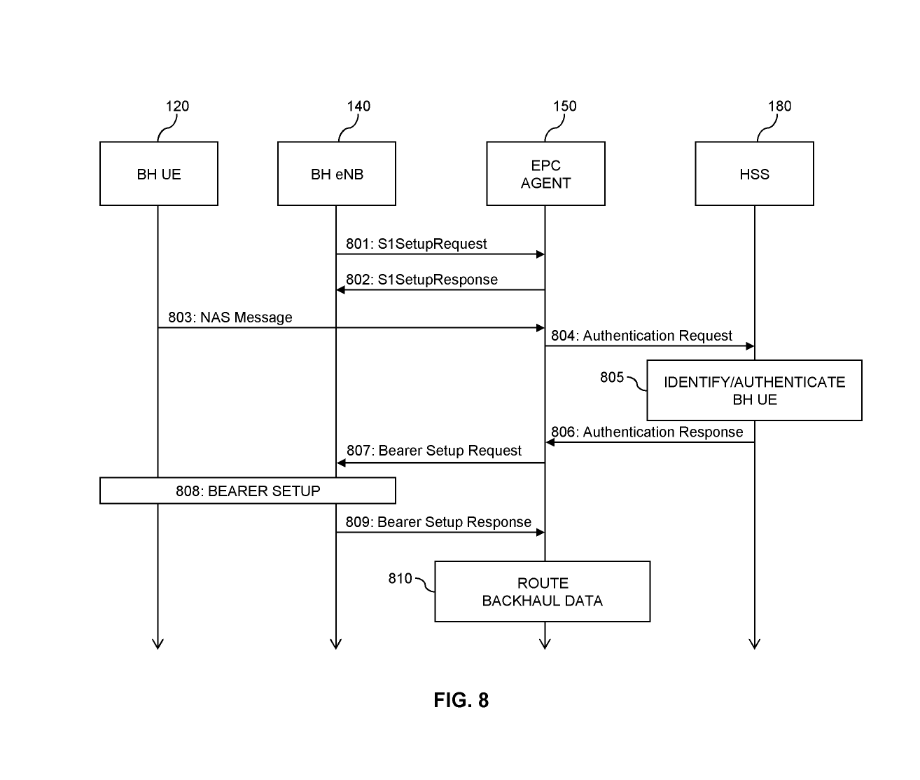

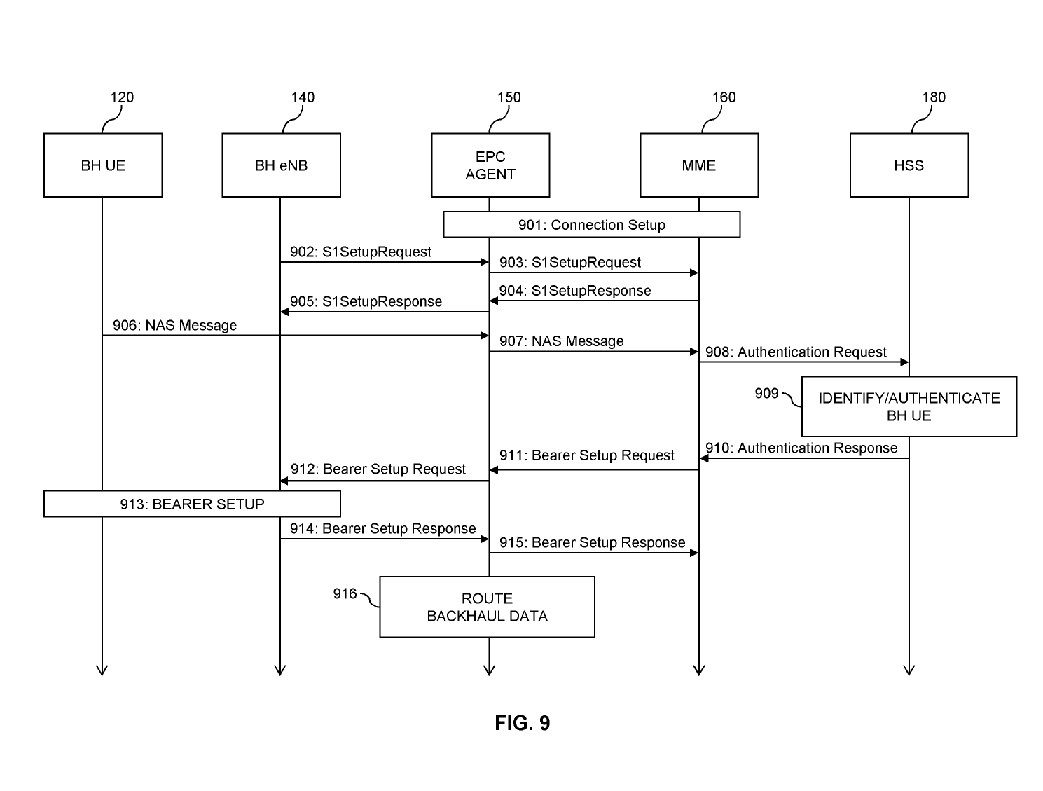

FIGS. 7, 8, and 9 show signaling diagrams for illustrating exemplary procedures which may be used when establishing the wireless backhaul connection 130. In the example of FIG. 7, it is assumed that no MME or HSS is available in the cellular network. In the example of FIG. 8, it is assumed that a HSS, but no MME is available in the cellular network. In the example of FIG. 9, it is assumed that both MME and HSS are available. In some implementations, the EPC agent 150 may automatically select between operation according to the procedures of FIG. 7, operation according to the procedures of FIG. 8, or operation according to the procedures of FIG. 9. For example, the EPC agent 150 may first check for the presence of a HSS or an MME and then adjust its operation accordingly.

The procedures of FIG. 7 involve the BH UE 120, the BH eNB 140, and the EPC agent 150. In these procedures, the BH eNB 140 may initially send an S1SetupRequest message 701 to the EPC agent 150, to establish an S1 control plane session with the EPC agent 150. The EPC agent 150 may then respond by sending an S1SetupResponse message 702 to the BH eNB 140.

The BH UE 120 may then send a NAS message 703, which is received by the EPC agent 150. The NAS message 703 may for example by an AttachRequest or ServiceRequest message.

As illustrated by step 704, the EPC agent 150 may then proceed by identifying and authenticating the BH UE 120. This may also include checking that the BH UE 120 is not a regular UE.

Having identified and authenticated the BH UE 120, the EPC agent 150 proceeds by sending a Bearer Setup Request 705 to the BH eNB 140. In response to the Bearer Setup Request 705, BH eNB 140 initiates setup of one or more radio bearers to the BH UE 120, as indicated by step 706. Having completed the setup of the radio bearers, the BH eNB 140 indicates the bearer setup completion to the EPC agent 150 by sending a Bearer Setup Response 707.

Having received the Bearer Setup Response 707, the EPC agent 150 may, as illustrated by step 708, start with routing the backhaul data to the wireless backhaul connection established over the radio bearers as setup in step 706.

The procedures of FIG. 8 involve the BH UE 120, the BH eNB 140, the EPC agent 150, and a HSS 180. In these procedures, the BH eNB 140 may initially send an S1SetupRequest message 801 to the EPC agent 150, to establish an S1 control plane session with the EPC agent 150. The EPC agent 150 may then respond by sending an S1SetupResponse message 802 to the BH eNB 140.

The BH UE 120 may then send a NAS message 803, which is received by the EPC agent 150. The NAS message 803 may for example by an AttachRequest or ServiceRequest message.

The EPC agent 150 may then proceed by sending an authentication request 804 to the HSS 180, which may then identify and authenticate the BH UE 120, as indicated by step 805. This may also include checking that the BH UE 120 is not a regular UE. Having authenticated the BH UE 120, the HSS 180 sends an authentication response 806 to the EPC agent 150, thereby confirming authentication of the BH UE 120.

The EPC agent 150 may then proceed by sending a Bearer Setup Request 807 to the BH eNB 140. In response to the Bearer Setup Request 807, BH eNB 140 initiates setup of one or more radio bearers to the BH UE 120, as indicated by step 808. Having completed the setup of the radio bearers, the BH eNB 140 indicates the bearer setup completion to the EPC agent 150 by sending a Bearer Setup Response 809.

Having received the Bearer Setup Response 809, the EPC agent 150 may, as illustrated by step 810, start with routing the backhaul data to the wireless backhaul connection established over the radio bearers as setup in step 808.

In the procedures of FIG. 8, usage of the HSS 180 for identification and authentication of the BH UE 120 may allow for a more efficient implementation of these processes. Specifically if there are multiple BH UEs, BH eNBs, and EPC agents in the system, a need to maintain lists of BH UEs in each of the EPC agents may be avoided. Rather, such lists can be managed in a centralized manner.

The procedures of FIG. 9 involve the BH UE 120, the BH eNB 140, the EPC agent 150, an MME 160, and a HSS 180. In these procedures, the EPC agent 150 initially sets up a connection with the MME 160, as indicated by step 901. Specifically, this connection setup may be used to configure the EPC agent 150 as proxy node between the BH eNB 140 and the MME 160.

The BH eNB 140 may then send an S1SetupRequest message 902 to the EPC agent 150, to establish an S1 control plane session. The EPC agent 150 forwards the S1SetupRequest 901, as indicated by message 903. The MME 160 may then respond by sending an S1SetupResponse message 904 to the EPC agent 150. The EPC agent 150 forwards the S1SetupResponse message 904 to the BH eNB 140, as indicated by message 905.

The BH UE 120 may then send a NAS message 906, which is received by the EPC agent 150. The NAS message 803 may for example by an AttachRequest or ServiceRequest message. The EPC agent 150 forwards the NAS message 906 to the MME 160, as indicated by message 907.

The MME 160 may then proceed by sending an authentication request 908 to the HSS 180, which may then identify and authenticate the BH UE 120, as indicated by step 909. This may also include checking that the BH UE 120 is not a regular UE. Having authenticated the BH UE 120, the HSS 180 sends an authentication response 910 to the MME 160, thereby confirming authentication of the BH UE 120.

The MME 160 may then proceed by sending a Bearer Setup Request 911 to EPC agent 150. The EPC agent 150 forwards the Bearer Setup Request to the BH eNB 140, as indicated by message 912. In response to the Bearer Setup Request 912, BH eNB 140 initiates setup of one or more radio bearers to the BH UE 120, as indicated by step 913. Having completed the setup of the radio bearers, the BH eNB 140 indicates the bearer setup completion to the EPC agent 150 by sending a Bearer Setup Response 914. The EPC agent 150 forwards the Bearer Setup Response to the MME 160, as indicated by message 915.

Having received the Bearer Setup Response 914, the EPC agent 150, as illustrated by step 916, may start with routing the backhaul data to the wireless backhaul connection established over the radio bearers as setup in step 913.

In the procedures of FIG. 9, usage of the MME 160 for controlling and managing the radio bearers of the wireless backhaul link 130 allows for efficiently integrating the BH UE 120, BH eNB 140, and EPC agent 150 with LTE infrastructure, e.g., if the cellular network is later updated with LTE infrastructure. Further, it becomes possible to utilize the BH eNB 140 also for serving regular UEs in a cell established by the BH eNB 140, e.g., as illustrated in FIG. 1. The radio spectrum used for the wireless backhaul connection may therefore be shared with the direct serving of UEs in the cell of the BH eNB 140. The available radio spectrum may therefore be utilized in an efficient manner.

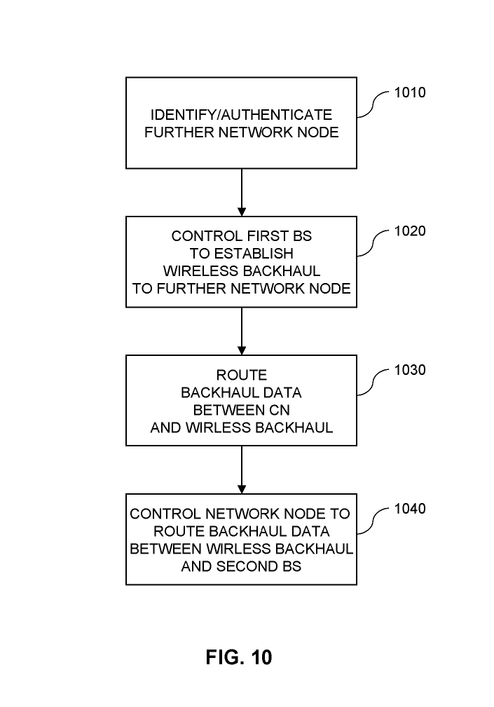

FIG. 10 shows a flowchart for illustrating a method for providing a backhaul connection in a cellular network, which may be used for implementing the above-described functionalities of the EPC agent in a network node.

At step 1010, the network node may identify and/or authenticate a further network node. This further network node may implement the above-described functionalities of the BH UE. The identification or authentication may be performed locally at the network node, e.g., on the basis of identifiers stored in the network node. Alternatively, also an external database may be used, e.g., as explained in connection with FIG. 9, where the HSS 180 is an example of such external database.

At step 1020, the network node controls a first BS of the cellular network to establish a wireless backhaul connection to the further network node. The wireless backhaul connection is implemented by an LTE RAT. For example, LTE TDD RAT or LTE FDD RAT may be used. The above-mentioned wireless backhaul connection 130 is an example of such wireless backhaul connection. The establishment of the wireless backhaul connection may involve signalling procedures as for example explained in connection with FIGS. 7, 8, and 9.

At step 1030, the network node routes backhaul data between the wireless backhaul connection and at least one CNs of the cellular network. As for example illustrated in FIG. 1, in some implementations the cellular network may include multiple CNs, e.g., for supporting different RATs. In such cases, the network node may perform the routing of the backhaul with respect to the different CNs. The routing of backhaul data between the wireless backhaul connection and the core network may be accomplished over a wired connection.

At step 1040, the network node controls the further network node to route the backhaul data between the wireless backhaul connection and at least one second BS which serves a cell of the cellular network. The at least one second BS may operate on the basis of a RAT which is different from the LTE RAT implementing the wireless backhaul connection. In other implementations, the second BS may operate on the basis of the same RAT as the LTE RAT implementing the wireless backhaul connection. The routing of backhaul data between the wireless backhaul connection and the second BS may be accomplished over a wired connection.

In some implementations, multiple network addresses, in particular IP addresses, may be allocated to the at least one second base station. This allocation may be performed by the network node. To facilitate implementation of the wireless backhaul connection, only a single network address, in particular IP address, may be allocated to the further network node. Such multiple network addresses of the at least one second BS may be used for differentiation purposes, e.g., to differentiate between multiple second BSs, between RATs, or between different types of the backhaul data.

In some implementations of the method of FIG. 10, the cellular network does not implement an MME. In some implementations, the cellular network also does not implement a HSS. In other implementations a HSS and/or MME may be available in the cellular network. If at least an MME is present, the further network node may also serve one or more UEs, i.e., act as an LTE BS which establishes a cell to serve such UEs.

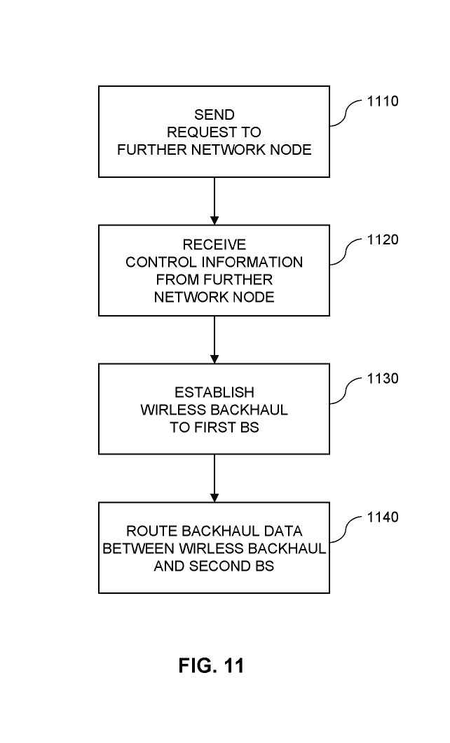

FIG. 11 shows a flowchart for illustrating a method for providing a backhaul connection in a cellular network, which may be used for implementing the above-described functionalities of the BH UE in a network node.

At step 1110, the network node may send a message to a further network node. The further network node may implement the above-described functionalities of the EPC agent. The message may for example correspond to a NAS message, such as the messages 703, 803, 906.

At step 1120, the network node may receive control data from the further network node. The control data may configure the network node with respect to establishment of a radio bearer or routing of backhaul data.

At step 1130, the network node establishes a wireless backhaul connection to a first BS of the cellular network. The wireless backhaul connection is implemented by an LTE RAT. For example, LTE TDD RAT or LTE FDD RAT may be used. The above-mentioned wireless backhaul connection 130 is an example of such wireless backhaul connection. The establishment of the wireless backhaul connection may involve signalling procedures as for example explained in connection with FIGS. 7, 8, and 9.

At step 1140, the network node routing backhaul data between the wireless backhaul connection and a at least one second BS. The second BS serves a cell of the cellular network. The at least one second BS may operate on the basis of a RAT which is different from the LTE RAT implementing the wireless backhaul connection. In other implementations, the second BS may operate on the basis of the same RAT as the LTE RAT implementing the wireless backhaul connection. The routing of backhaul data between the wireless backhaul connection and the second BS may be accomplished over a wired connection. The routing of backhaul data between the wireless backhaul connection and the second BS may be accomplished over a wired connection.

In some implementations, the wireless backhaul connection may be for providing a backhaul connection to a plurality of second BS, each serving a respective cell of the cellular network. Such multiple second BSs may also operate on the basis of two or more different RATs, e.g., as illustrated in FIG. 1. In such scenarios, the network node may perform the routing of the backhaul data with respect to each of the different BSs.

In some implementations, multiple network addresses, in particular IP addresses, may be allocated to the at least one second base station. To facilitate implementation of the wireless backhaul connection, only a single network address, in particular IP address, may be allocated to the network node. Such multiple network addresses of the at least one second BS may be used for differentiation purposes, e.g., to differentiate between multiple second BSs, between RATs, or between different types of the backhaul data.

In some implementations of the method of FIG. 11, the cellular network does not implement an MME. In some implementations, the cellular network also does not implement a HSS. In other implementations a HSS and/or MME may be available in the cellular network.

The methods as described in connection with FIGS. 10 and 11 may be combined with each other in a network system including two or more of the described network nodes. For example, in a system including the network node of FIG. 10 and the network node of FIG. 11, the network node of FIG. 10 may control the network node of FIG. 11 according to the illustrated methods. Such system may also include a still further network node, which may implement the above-described functionalities of the BH eNB. In particular, the latter network node and the network node of FIG. 11 could then act as endpoints of the wireless backhaul connection, both being controlled by the network node of FIG. 10.

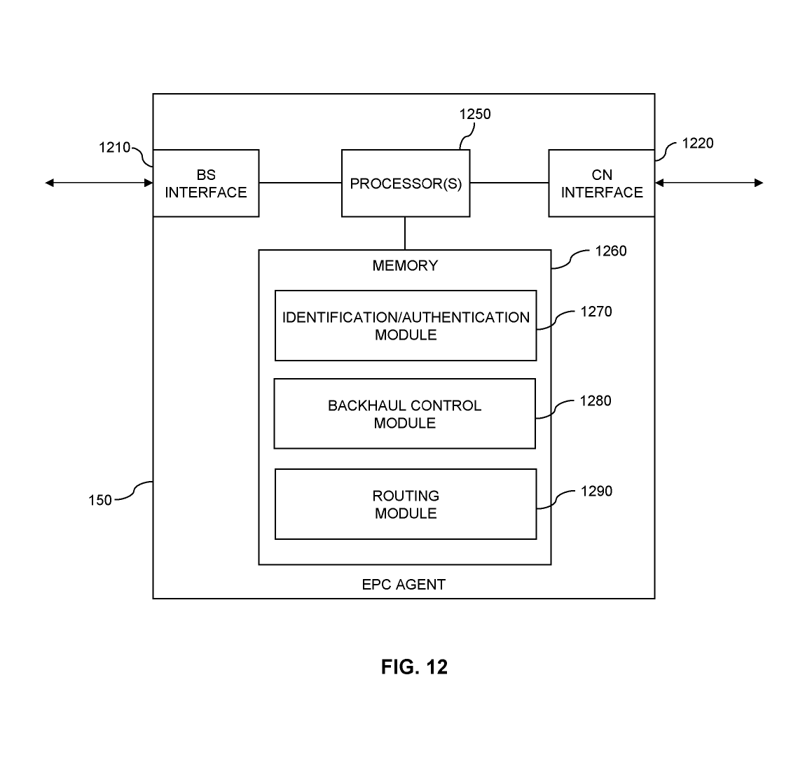

FIG. 12 illustrates exemplary structures of a network node which may be used for implementation of the EPC agent 150.

As illustrated, the network node may be provided with an BS interface 1210 with respect to the BH eNB. The BS interface 1210 may use a protocol stack as illustrated in FIGS. 4, 5, and 6. Further, the network node may be provided with a CN interface 1220 for connecting to one or more CNs. Also the CN interface 1220 may be based on any appropriate technology, e.g., an Ethernet based technology with wired physical medium.

Further, the network node includes at least one processor 1250 coupled to the interfaces 1210, 1220 and a memory 1260 coupled to the at least one processor 1250. The memory 1260 may include a Read Only Memory (ROM), e.g., a flash ROM, a Random Access Memory (RAM), e.g., a Dynamic RAM (DRAM) or Static RAM (SRAM), a mass storage, e.g., a hard disk or solid state disk, or the like. The memory 1260 includes suitably configured program code modules to be executed by the processor 1260 so as to implement the above-described functionalities of the EPC agent. More specifically, the memory 1260 may include an identification/authentication module 1270 so as to implement the above-mentioned functionalities for identification and/or authentication of the BH UE. Further, the memory 1260 may include a backhaul control module 1280 so as to implement the above-described functionalities of controlling and managing the wireless backhaul connection as well as controlling the routing of the backhaul data by the BH UE. Further, the memory 1260 may include a routing module 1290 so as to implement the above-described functionalities of routing backhaul data between the wireless backhaul connection and one or more CNs.

It is to be understood that the structures as illustrated in FIG. 12 are merely schematic and that the network node may actually include further components which, for the sake of clarity, have not been illustrated, e.g., further interfaces or additional processors. For example, a dedicated processor could be used for implementing the routing functionalities. Also, it is to be understood that the memory 1260 may include further types of program code modules which have not been illustrated, e.g., program code modules for implementing specific protocol handling functionalities. In some implementations, also a computer program may be provided for implementing functionalities of the network node, e.g., in the form of a physical medium storing the program code and/or other data to be stored in the memory 1260 or by making the program code available for download.

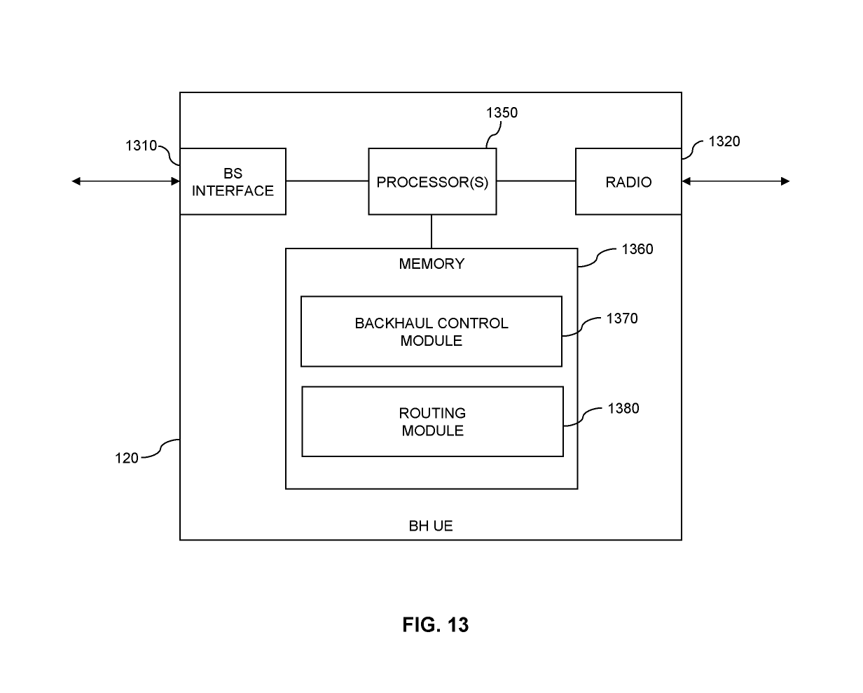

FIG. 13 illustrates exemplary structures of a network node which may be used for implementation of the BH UE 120.

As illustrated, the network node may be provided with an BS interface 1310 with respect to one or more BSs serving cells, such as the BSs 110-1, 110-2, 110-3 in FIG. 1. The BS interface 1310 may be based on any appropriate technology, e.g., an Ethernet based technology with wired physical medium. Further, the network node may be provided with a radio interface 1320 for connecting to the BH eNB. The radio interface may correspond to the LTE Uu interface.

Further, the network node includes at least one processor 1350 coupled to the interfaces 1310, 1320 and a memory 1360 coupled to the at least one processor 1350. The memory 1260 may include a ROM, e.g., a flash ROM, a RAM, e.g., a DRAM or SRAM, a mass storage, e.g., a hard disk or solid state disk, or the like. The memory 1360 includes suitably configured program code modules to be executed by the processor 1360 so as to implement the above-described functionalities of the BH UE. More specifically, the memory 1360 may include a backhaul control module 1370 so as to implement the above-described functionalities of controlling and managing the wireless backhaul connection. Further, the memory 1360 may include a routing module 1380 so as to implement the above-described functionalities of routing backhaul data between the wireless backhaul connection and the one or more BSs connected via the BS interface 1210.

It is to be understood that the structures as illustrated in FIG. 13 are merely schematic and that the network node may actually include further components which, for the sake of clarity, have not been illustrated, e.g., further interfaces or additional processors. For example, a dedicated processor could be used for implementing the routing functionalities. Also, it is to be understood that the memory 1360 may include further types of program code modules which have not been illustrated, e.g., program code modules for implementing specific protocol handling functionalities or radio link control functionalities which are similar to those of a regular LTE UE. In some implementations, also a computer program may be provided for implementing functionalities of the network node, e.g., in the form of a physical medium storing the program code and/or other data to be stored in the memory 1360 or by making the program code available for download.

As can be seen, the concepts as explained above may be used to efficiently provide a backhaul connection to a BS of a cellular network. The concepts may be applied for BSs of various RATs, without requiring adaptation of CN infrastructure.

It is to be understood that the examples and embodiments as explained above are merely illustrative and susceptible to various modifications. For example, the concepts could be used in various types of cellular network, which are based on different types or combinations of RATs. For example, the concepts could be applied for providing a backhaul connection to BSs which use a RAT which is different from the above-mentioned exemplary RATs, e.g., a WiFi RAT or CDMA2000 RAT. Further, it is to be understood that the above concepts may be implemented by using correspondingly designed software in existing network devices, or by using dedicated network device hardware. Also, it is to be understood that each of the illustrated nodes may be implemented as single device or by multiple interacting devices, e.g., by a device cloud or other kind of distributed system.

1. A method for providing a backhaul connection in a cellular network, the method comprising:
a network node controlling a first base station of the cellular network to establish a wireless backhaul connection to a further network node, said wireless backhaul connection being implemented by an LTE radio access technology;
the network node routing backhaul data between the wireless backhaul connection and at least one core network of the cellular network; and
the network node controlling the further network node to route the backhaul data between the wireless backhaul connection and at least one second base station which serves a cell of the cellular network.

2. The method according to claim 1, comprising:
the network node identifying the further network node.

3. The method according to claim 1, comprising:
the network node authenticating the further network node.

4. The method according to claim 1,
wherein the at least one second base station operates on the basis of a radio access technology which is different from the LTE radio access technology implementing the wireless backhaul connection.

5. The method according to claim 1,
wherein the routing of backhaul data between the wireless backhaul connection and the second base station is performed over a wired connection.

6. The method according to claim 1,
wherein the routing of backhaul data between the wireless backhaul connection and the core network is performed over a wired connection.

7. The method according to claim 1,
wherein the network node routes the backhaul data between the wireless backhaul connection and a plurality of core networks of the cellular network.

8. The method according to claim 1,
wherein the cellular network does not implement a Mobility Management Entity.

9. The method according to claim 1,
wherein the first base station serves at least one user equipment.

10. The method according to claim 1,
wherein the cellular network does not implement a Home Subscriber Server.

11.-16. (canceled)

17. A network node for providing a backhaul connection in a cellular network, the network node comprising:
a first interface with respect to at least one core network of the cellular network;
a second interface with respect to a first base station of the cellular network; and
at least one processor, the at least one processor being configured to:
control the first base station to establish a wireless backhaul connection to a further network node, said wireless backhaul connection being implemented by an LTE radio access technology,
route backhaul data between the wireless backhaul connection and the at least one core network connected to the first interface, and
control the further network node to route the backhaul data between the wireless backhaul connection and at least one second base station which serves a cell of the cellular network.

18. The network node according to claim 17,
wherein the at least one processor is configured to identify the further network node.

19. The network node according to claim 17,
wherein the at least one processor is configured to authenticate the further network node.

20. The network node according to claim 17,
wherein the at least one second base station operates on the basis of a radio access technology which is different from the LTE radio access technology implementing the wireless backhaul connection.

21. The network node according to claim 17,
wherein the routing of backhaul data between the wireless backhaul connection and the second base station is performed over a wired connection.

22. The network node according to claim 17,
wherein the routing of backhaul data between the wireless backhaul connection and the core network is performed over a wired connection.

23. The network node according to claim 17,
wherein the at least one processor is configured to route the backhaul data between the wireless backhaul connection and a plurality of core networks of the cellular network.

24. (canceled)

25. The network node according to claim 17,
wherein the first base station serves at least one user equipment.

26.-33. (canceled)

34. A computer program product comprising a non-transitory computer readable medium storing computer program code to be executed by at least one processor of a network node of a cellular network, wherein execution of the program code causes the network node to:
control a first base station of the cellular network to establish a wireless backhaul connection to a further network node, said wireless backhaul connection being implemented by an LTE radio access technology;
route backhaul data between the wireless backhaul connection and at least one core network of the cellular network; and
control the further network node to route the backhaul data between the wireless backhaul connection and at least one second base station which serves a cell of the cellular network.
